(19) United States
(12) Patent Application Publication
(10) Pub. No.: US 2021/0295451 A1
(43) Pub. Date: Sep. 23, 2021

(54) INFORMATION PROVIDING SYSTEM

(71) Applicant: HONDA MOTOR CO., LTD., Tokyo (JP)

(72) Inventors: Noboru Kawaguchi, Wako-shi (JP); Masanori Fujinuma, Wako-shi (JP); Sei Watanabe, Wako-shi (JP); Tomoyuki Kuriyama, Tokyo (JP); Yutaka Tsuji, Tokyo (JP)

(21) Appl. No.: 17/204,139

(22) Filed: Mar. 17, 2021

(30) Foreign Application Priority Data
Mar. 19, 2020 (JP) 2020-049808

(51) Int. Cl. G06Q 40/00; G06Q 50/06; G06Q 30/00; G06Q 30/02; G06Q 10/00

(52) U.S. Cl. CPC G06Q 40/12; G06Q 50/06; G06Q 30/0645; G06Q 30/0283; G06Q 10/30; G06Q 30/01

(57) ABSTRACT

Provided is an information providing system capable of promoting use of services relating to a lawn. An information providing system 1 includes a gardener terminal 200 and a customer terminal 300 communicably connected to the gardener terminal 200. The gardener terminal 200 includes a lawn state information generating unit 211, and the customer terminal 300 includes a lawn selecting unit 311. In a case in which a contract for a transaction relating to a lawn is concluded between a customer 30 using the customer terminal 300 and a gardener 20 using the gardener terminal 200, the lawn state information generating unit 211 generates lawn state information indicating a state of the lawn provided by the gardener 20, and transmits the lawn state information to the customer terminal 300, and the lawn selecting unit 311 selects the lawn provided by the gardener 20 based on the lawn state information.

This application is based on and claims the benefit of priority from Japanese Patent Application No. 2020-049808, filed on 19 Mar. 2020, the content of which is incorporated herein by reference.

### BACKGROUND OF THE INVENTION

### Field of the Invention

The present invention relates to an information providing system.

### Related Art

Conventionally, in order to protect the global environment and effectively utilize resources, various technologies for recycling and reusing plants have been proposed (for example, refer to Japanese Unexamined Patent Application, Publication No. 2005-71343). The technique disclosed in Japanese Patent Application Laid-Open No. 2005-71343 discloses that, in order to promote recycling, the selling price of organic materials made from waste plants is discounted in accordance with the collection fee of waste plants.

Patent Document 1: Japanese Unexamined Patent Application, Publication No. 2005-71343

### SUMMARY OF THE INVENTION

Lawns used in parks, hotels, event halls, golf courses, and the like require periodic maintenance, such as harvesting, watering, and providing of fertilizer. In order to regularly perform such maintenance, a user who uses lawns often requests a gardener (also referred to as a landscape gardener) that provides services relating to lawns such as maintenance to manage the lawns. However, under the conventional method, it is difficult to match a gardener who wants to provide the service relating to the lawns with a user (customer) who wants the service relating to the lawns, and to effectively utilize the service relating to the lawns.

It is, therefore, an object of the present invention to provide an information providing system capable of promoting the use of services relating to a lawn.

An information providing system (for example, an information providing system 1 described later) according to the present invention includes: a gardener terminal (for example, a gardener terminal 200); and a customer terminal (for example, a customer terminal 300) communicably connected to the gardener terminal, in which the gardener terminal includes a lawn state information generating unit (for example, a lawn state information generating unit 211), the customer terminal includes a lawn selecting unit (for example, a lawn selecting unit 311), and, in a case in which a contract for a transaction relating to a lawn is concluded between a customer using the customer terminal and a gardener using the gardener terminal, the lawn state information generating unit generates lawn state information indicating a state of the lawn provided by the gardener, and transmits the lawn state information to the customer terminal, and the lawn selecting unit selects the lawn provided by the gardener based on the lawn state information.

Furthermore, the lawn state information includes a use state of the lawn and a fee for a lawn transaction and the gardener terminal further includes a lawn fee setting unit (for example, a lawn fee setting unit 212 described later) that sets the fee for the lawn transaction according to the use state of the lawn.

Furthermore, the lawn fee setting unit sets the fee for the lawn transaction to a predetermined price in a case in which the use state of the lawn is indicated as unused, and sets the fee for the lawn transaction to a price obtained by subtracting an amount of money at a predetermined rate from the predetermined price, in a case in which the use state of the lawn is indicated as used.

Furthermore, in a case in which the use state of the lawn is indicated as used, if the lawn cannot be regenerated, the lawn fee setting unit sets the fee for the lawn transaction to a price obtained by subtracting an amount of money corresponding to an energy amount generated by using a resulting fermented product produced by fermenting the lawn, from the predetermined price.

According to the present invention, it is possible to provide an information providing system capable of promoting the use of services relating to a lawn.

### BRIEF DESCRIPTION OF THE DRAWINGS

FIG. 1 is a schematic diagram showing a relationship among a management company, a gardener, and a customer according to the present embodiment;

FIG. 2 is a diagram showing an example of the configuration of an information providing system according to the present embodiment;

FIG. 3 is a diagram showing an example of the configuration of an information providing device;

FIG. 4 is a diagram showing an example of the configuration of a gardener terminal;

FIG. 5 is a diagram showing a relationship between a utilized area of a lawn and a rate of subtraction of a fee for a lawn transaction, for a case where the lawn can be regenerated;

FIG. 6 is a diagram showing a relationship between a utilized area of a lawn and a rate of subtraction of the fee for the lawn transaction, for a case where the lawn cannot be regenerated;

FIG. 7 is a diagram showing an example of the configuration of a customer terminal; and

FIG. 8 is a flowchart showing a flow of processing of the information providing system.

### DETAILED DESCRIPTION OF THE INVENTION

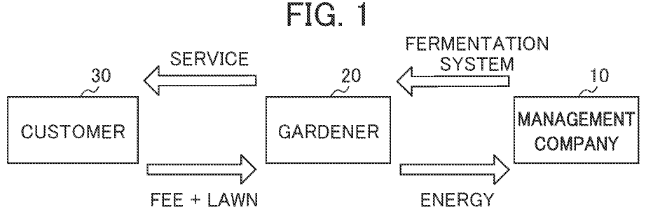

Embodiments of an information providing system of the present invention will be described below with reference to the drawings. FIG. 1 is a schematic diagram showing a relationship among a management company 10, a gardener 20, and a customer 30 according to the present embodiment.

In the present embodiment, the management company 10 provides a fermentation system to the gardener 20 for fermenting the lawn which has been pruned and has become a waste, and generating energy using the fermented product.

The fermentation system includes, for example, a fermentation device for fermenting lawns, a biogas acquisition device for acquiring a biogas such as methane gas, carbon monoxide, or carbon dioxide from a fermented product obtained by fermenting the lawn, an energy generation device for generating hydrogen and energy such as electricity, using the biogas, and an energy storage device for storing the generated energy. The energy generating device has, for example, a reformer for generating hydrogen from biogas and a generator for biogas for generating electricity from biogas. It should be noted that the fermentation system may be provided with another configuration for fermenting lawns to generate energy from the fermented product.

Such a fermentation system is provided or lent from the management company 10 to the gardener 20 for a fee or free of charge. Furthermore, the management company 10 may perform maintenance of the fermentation system or the like for a fee or free of charge. The management company 10 is supplied with energy generated by the fermentation system from the gardener 20.

The gardener 20 is also referred to as a landscape gardener, and provides the customer 30 with lawn management such as periodic lawn mowing and lawn-related services such as lawn rental. Furthermore, the gardener 20 ferments the waste lawn using the fermentation system provided by the management company 10. Thereafter, the gardener 20 uses a fermentation system to generate energy of, for example, hydrogen and electricity from the fermented product.

The gardener 20 grows the lawn in order to provide services relating to the lawn. Thereafter, a used lawn or an unnecessary lawn is used for fermentation as waste. In addition, the gardener 20 may use a solution of fermented lawns or a biogas such as carbon dioxide or the like as a fertilizer for growing lawns.

The customer 30 is, for example, a park management company, a hotel, an event management company, a golf course management company, an individual user, or the like, and receives services relating to lawns from the gardener 20. The customer 30 pays a fee to the gardener 20 as a compensation for services relating to lawns. In addition, the customer 30 provides the gardener 20 with lawns, which are waste generated by management of the lawns such as lawn mowing.

As described above, in the present embodiment, the management company 10, the gardener 20, and the customer 30 have a relationship of giving and receiving services relating to lawns, energy generated from fermented lawns, and compensation for them.

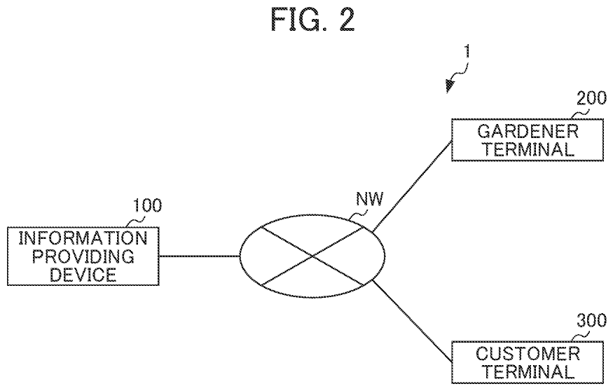

FIG. 2 is a diagram showing an example of a configuration of an information providing system 1 according to the present embodiment. As shown in FIG. 2, the information providing system 1 includes an information providing device 100, a gardener terminal 200, and a customer terminal 300.

The information providing device 100 is used by the management company 10 shown in FIG. 1, and is connected to the gardener terminal 200 and the customer terminal 300 via the network NW so as to be able to communicate with each other.

The gardener terminal 200 is used by the gardener 20 shown in FIG. 1, and is connected to the information providing device 100 and the customer terminal 300 so as to be able to communicate with each other via the network NW. The gardener terminal 200 provides gardener information about services related to lawns to the information providing device 100.

The customer terminal 300 is used by the customer 30 shown in FIG. 1, and is connected to the information providing device 100 and the gardener terminal 200 so as to be able to communicate with each other via the network NW. The customer terminal 300 provides the gardener terminal 200 with request information relating to the lawn.

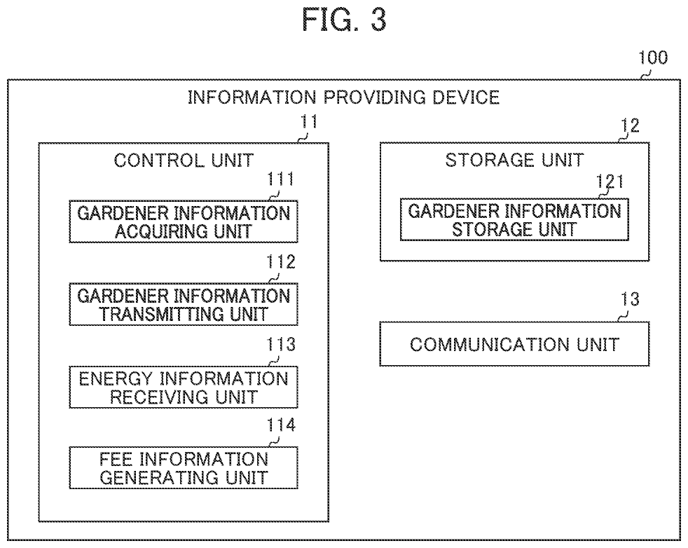

FIG. 3 is a diagram showing an example of a configuration of the information providing device 100. As shown in FIG. 2, the information providing device 100 includes a control unit 11, a storage unit 12, and a communication unit 13.

The control unit 11 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed when the storage medium is inserted to a drive device.

The storage unit 12 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 13 is a communication interface for communicating with external devices such as the gardener terminal 200 and the customer terminal 300 through the network NW.

Next, the processing of the control unit 11 will be described. As shown in FIG. 3, the control unit 11 includes a gardener information acquiring unit 111, a gardener information transmitting unit 112, an energy information receiving unit 113, and a fee information generating unit 114.

Upon receiving request information from the customer terminal 300, the gardener information acquiring unit 111 refers to the gardener information storage unit 121 to acquire gardener information matching the request information.

Here, the request information includes the content of the service and the fee for the service relating to lawns desired by the customer 30. Furthermore, the request information may include a variety of the lawn provided by the gardener, a type of fertilizer used for the lawn, a method of treating a lawn produced by a trade relating to the lawn, and energy generated using the lawn, and the like.

The gardener information storage unit 121 stores gardener information received in advance from the gardener terminal 200 and accumulated therein. The gardener information includes the content of services relating to the lawn by the gardener, the fee for the services relating to the lawn, the variety of the lawn provided by the gardener, the type of fertilizer used for the lawn, the method of treating the lawn produced by the trade relating to the lawn, and the energy produced using the lawn. In addition, the gardener information may further include information such as a service provision time relating to the lawn, a location of the gardener, and the like.

The gardener information transmitting unit 112 transmits the gardener information acquired by the gardener information acquiring unit 111 to the customer terminal 300. The gardener information transmitted to the customer terminal 300 allows the customer 30 using the customer terminal 300 to determine with which gardener 20 to contract.

The energy information receiving unit 113 receives the energy information including the data of the energy amount of the energy generated using the lawn produced by the transaction relating to the lawn from the gardener terminal 200 when the transaction relating to the lawn is concluded between the customer 30 using the customer terminal 300 and the gardener 20 using the gardener terminal 200. It should be noted that the information providing device 100 generates contract information indicating the conclusion of a contract for a transaction relating to the lawn, and transmits the contract information to the gardener terminal 200 and the customer terminal 300 relating to the transaction relating to the lawn. Furthermore, the contract information may be generated by the gardener terminal 200 and/or the customer terminal 300, and transmitted to the information providing device 100, the gardener terminal 200, and the customer terminal 300 relating to the transaction relating to the lawn.

More specifically, the energy information receiving unit 113 receives, from the gardener terminal 200 for which the contract has been established, energy information including the data of the energy amount of the energy generated by fermenting the lawn produced by the transaction relating to the lawn and using the fermented product.

Here, the transaction relating to the lawn includes providing the customer 30 with, for example, the management of the lawn such as periodic lawn mowing and services relating to the lawn such as rental of the lawn from the gardener 20, and the payment of a fee from the customer 30 to the gardener 20 in compensation of the services relating to the lawn. Furthermore, the energy information includes, for example, data relating to the energy amount and the energy type of the energy generated by using the fermented product.

The fee information generating unit 114 generates fee information according to the energy amount, and transmits the fee information to the gardener terminal 200. Here, the fee information includes, for example, a predetermined price corresponding to the energy amount, and a commission.

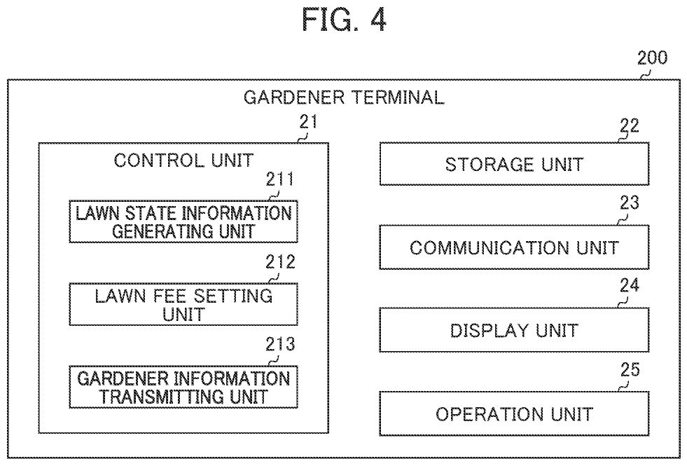

FIG. 4 is a diagram showing an example of the configuration of the gardener terminal 200. As shown in FIG. 4, the gardener terminal 200 includes a control unit 21, a storage unit 22, a communication unit 23, a display unit 24, and an operation unit 25.

The control unit 21 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed by mounting the storage medium on a drive device.

The storage unit 22 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 23 is a communication interface for communicating with the information providing device 100 and external devices such as the customer terminal 300 through the network NW. The display unit 24 is a device for displaying an image. The display unit 24 is, for example, an LCD, an organic EL, or the like.

The operation unit 25 includes a button or the like for operating the display unit 24. In addition, the display unit 24 and the operation unit 25 may be a touch screen in which these functions are integrally provided. In this case, the operation unit 25 may be a GUI switch to be displayed on the display unit 24. Furthermore, the operation unit 25 may be a mechanical button.

Next, the processing of the control unit 21 will be described. As shown in FIG. 4, the control unit 21 includes a lawn state information generating unit 211, a lawn fee setting unit 212, and a gardener information transmitting unit 213.

When a contract for a transaction relating to a lawn is concluded between a customer using the customer terminal 300 and a gardener 20 using the gardener terminal 200, the lawn state information generating unit 211 generates lawn state information indicating the state of the lawn provided by the gardener 20, and transmits the lawn state information to the customer terminal 300. Herein, the lawn state information includes a use state of the lawn and a fee for a lawn transaction. It should be noted that the fee for the lawn transaction includes a fee for managing the lawn and a fee to be paid as a compensation for services relating to the lawn such as a rental fee for renting the lawn.

It should be noted that the use state of the lawn may be inputted by the operation unit 25, an image of the lawn may be captured by an imaging device such as a camera (not shown), and the state of the lawn may be determined from the image of the lawn captured using an image processing technique.

The lawn fee setting unit 212 sets the fee for the lawn transaction in accordance with the use state of the lawn. More specifically, when the use state of the lawn indicates unused, the lawn fee setting unit 212 sets the fee for the lawn transaction to a predetermined price. In addition, when the use state of the lawn indicates used, the lawn fee setting unit 212 sets the fee for the lawn transaction to a price obtained by subtracting the amount of money at a predetermined rate from the predetermined price.

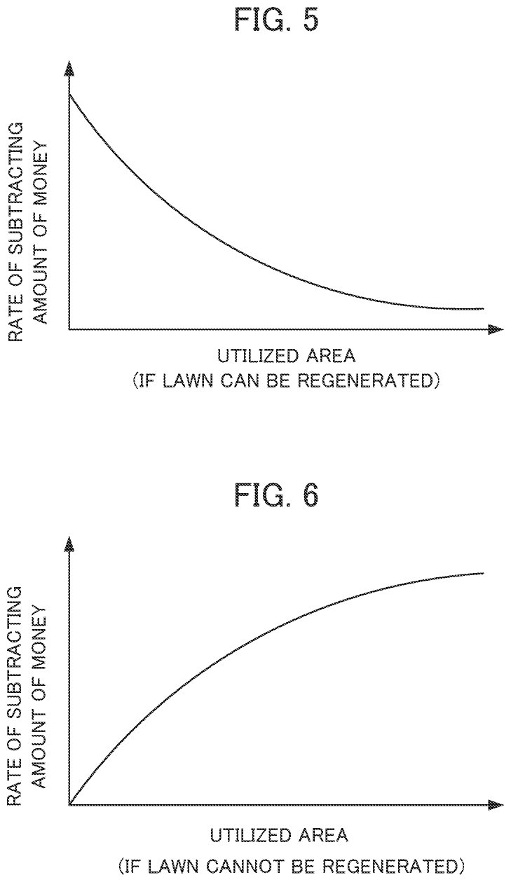

FIG. 5 is a diagram showing a relationship between a utilized area of a used lawn and a rate of subtraction of a fee for the lawn transaction, in a case where the lawn can be regenerated. As shown in FIG. 5, the lawn fee setting unit 212 decreases the rate of subtraction of the fee for the lawn transaction as the utilized area of the used lawn increases. That is, for the fee relating to lawn transaction, as the utilized area of the used lawn increases, the discount rate discounted from a predetermined price decreases.

Furthermore, the lawn fee setting unit 212 may vary the fee for the lawn transaction from a predetermined price based on other factors. For example, when the use state of the lawn indicates used, the lawn fee setting unit 212 may set the fee for the lawn transaction to a price obtained by subtracting the amount of money at a predetermined rate from the predetermined price in accordance with the number of times of use of the lawn.

Furthermore, when the lawn is regenerated and reused, the lawn fee setting unit 212 may set the fee for the lawn transaction to a price obtained by subtracting the amount of money at a predetermined rate from the predetermined price in accordance with the workload spent on the regeneration. In addition, generally speaking, in summer and winter, it tends to take more time and labor to grow lawns than in spring and autumn. Therefore, the lawn rate setting unit 212 may set the rate of subtracting the amount of money at a predetermined rate from the predetermined price in summer and winter to be smaller than that in spring and autumn.

In addition, if the lawn is in a used state and the lawn is not renewable, the lawn fee setting unit 212 sets the fee for the lawn transaction to a price obtained by subtracting an amount of money corresponding to the energy amount generated by using the fermented product obtained by fermenting the lawn from a predetermined price.

FIG. 6 is a diagram showing a relationship between a utilized area of a lawn and a rate of subtraction of a fee for the lawn transaction, in a case where the lawn cannot be regenerated.

As shown in FIG. 6, the lawn fee setting unit 212 decreases the rate of subtracting the amount of money corresponding to the energy amount generated by using the fermented product obtained by fermenting the lawn from the fee relating to the transaction as the utilized area of the used lawn increases. In other words, for the fee for the lawn transaction, the discount rate discounted from a predetermined price increases because the energy amount generated by using fermented products obtained by fermenting the lawn increases as the utilized area of used lawn increases.

With reference to FIG. 5 again, the gardener information transmitting unit 213 transmits the gardener information inputted by the operation unit 25 or the like to the information providing device 100.

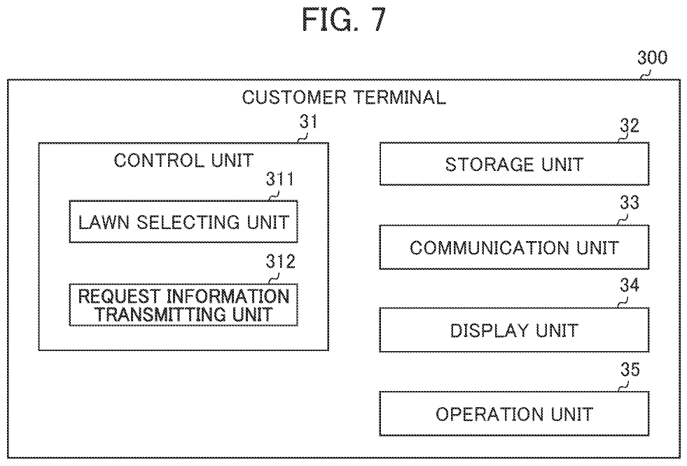

FIG. 7 is a diagram showing an example of the configuration of the customer terminal 300. As shown in FIG. 7, the customer terminal 300 includes a control unit 31, a storage unit 32, a communication unit 33, a display unit 34, and an operation unit 35.

The control unit 31 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed when the storage medium is inserted to a drive device.

The storage unit 32 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 33 is a communication interface for communicating with the information providing device 100 and external devices such as the gardener terminal 200 through the network NW. The display unit 34 is a device for displaying an image. The display unit 34 is, for example, an LCD, an organic EL, or the like.

The operation unit 35 includes a button or the like for operating the display unit 34. In addition, the display unit 34 and the operation unit 35 may be a touch screen in which these functions are integrally provided. In this case, the operation unit 35 may be GUI switches displayed on the display unit 34. Furthermore, the operation unit 35 may be mechanical buttons.

Next, the processing of the control unit 31 will be described. As shown in FIG. 7, the control unit 31 includes a lawn selecting unit 311 and a request information transmitting unit 312.

The lawn selecting unit 311 selects a lawn provided by the gardener 20 based on the lawn state information provided from the gardener terminal 200. As described above, the lawn state information includes the use state of the lawn and the fee for to the lawn transaction. As a result, the customer 30 using the customer terminal 300 can select a service relating to the lawn in accordance with the lawn in a desired state or the fee.

The request information transmitting unit 312 transmits the request information inputted by the operation unit 35 or the like to the information providing device 100.

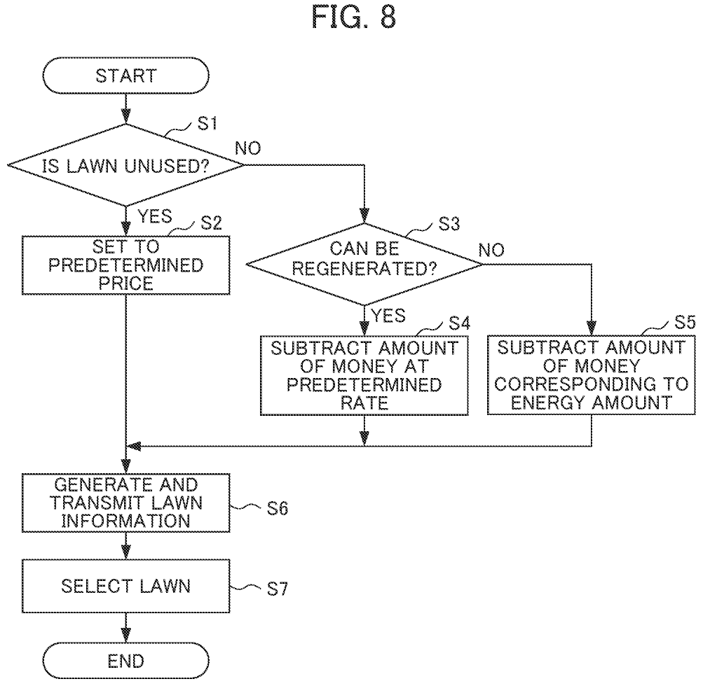

FIG. 8 is a flowchart showing the flow of processing of the information providing system 1. In step S1, the lawn fee setting unit 212 determines whether or not the lawn provided by the gardener 20 is indicated as unused. In a case in which it is determined that the lawn is unused (YES), the processing advances to step S2. On the other hand, in a case in which the lawn is indicated as used (NO), the processing advances to step S3. In step S2, the lawn fee setting unit 212 sets the fee for the lawn transaction to a predetermined price.

In step S3, the lawn fee setting unit 212 determines whether or not the lawn can be regenerated. In a case in which the lawn can be regenerated (YES), the processing advances to step S4. On the other hand, in a case in which the lawn cannot be regenerated (NO), the processing advances to step S5.

In step S4, the lawn fee setting unit 212 sets the fee for the lawn transaction to a price obtained by subtracting the amount of money at a predetermined rate from the predetermined price. In step S5, the lawn fee setting unit 212 sets the fee for the lawn transaction to a price obtained by subtracting the amount of money corresponding to the energy amount generated by using a resulting fermented product obtained by fermenting the lawn from the predetermined price.

In step S6, the lawn state information generating unit 211 generates lawn state information indicating the state of the lawn provided by the gardener 20, and transmits the lawn state information to the customer terminal 300. In step S7, the lawn selecting unit 311 of the customer terminal 300 selects the lawn provided by the gardener 20 based on the lawn state information provided from the gardener terminal 200.

According to the present embodiment, the following effects can be achieved, for example. The information providing system 1 includes the gardener terminal 200 and the customer terminal 300 communicably connected to the gardener terminal 200. The gardener terminal 200 includes the lawn state information generating unit 211, and the customer terminal 300 includes the lawn selecting unit 311. In a case in which a contract for a transaction relating to a lawn is concluded between the customer 30 using the customer terminal 300 and the gardener 20 using the gardener terminal 200, the lawn state information generating unit 211 generates lawn state information indicating a state of the lawn provided by the gardener 20, and transmits the lawn state information to the customer terminal 300, and the lawn selecting unit 311 selects the lawn provided by the gardener 20 based on the lawn state information.

As a result, the gardener terminal 200 transmits the lawn state information indicating the state of the lawn to the customer terminal 300, and the customer terminal 300 selects the lawn based on the lawn state information. Therefore, since the information providing system 1 can exchange information on services relating to the lawn between the gardener 20 using the gardener terminal 200 and the customer 30 using the customer terminal 300, the use of services relating to the lawn can be promoted between the gardener 20 and the customer 30.

Furthermore, the lawn state information includes a use state of the lawn and a fee for a lawn transaction and the gardener terminal 200 further includes a lawn fee setting unit 212 that sets the fee for the lawn transaction according to the use state of the lawn. As a result, the gardener terminal 200 can set the fee for the lawn transaction in accordance with the use state of the lawn, so that the information providing system 1 can preferably carry out the transaction of the service relating to the lawn.

Furthermore, the lawn fee setting unit 212 sets the fee for the lawn transaction to a predetermined price in a case in which the use state of the lawn is indicated as unused, and sets the fee for the lawn transaction to a price obtained by subtracting an amount of money at a predetermined rate from the predetermined price, in a case in which the use state of the lawn is indicated as used. As a result, the gardener terminal 200 can set the fee for the lawn transaction in accordance with the use state of the lawn.

Furthermore, in a case in which the use state of the lawn is indicated as used, if the lawn cannot be regenerated, the lawn fee setting unit 212 sets the fee for the lawn transaction to a price obtained by subtracting an amount of money corresponding to an energy amount generated by using a resulting fermented product produced by fermenting the lawn, from the predetermined price. As a result, the gardener terminal 200 can set the fee for the lawn transaction in accordance with the energy amount generated by using the resulting fermented product obtained by fermenting the lawn.

While an embodiment of the present invention has been described above, the present invention is not intended to be limited thereto. Within the spirit of the present invention, the details of the configuration may be modified as appropriate.

### EXPLANATION OF REFERENCE NUMERALS

1 information providing system

100 information providing device

200 gardener terminal

211 lawn state information generating unit

212 lawn fee setting unit

300 customer terminal

311 lawn selecting unit

What is claimed is:

1. An information providing system comprising:
a gardener terminal; and
a customer terminal communicably connected to the gardener terminal,
wherein the gardener terminal includes a lawn state information generating unit,
wherein the customer terminal includes a lawn selecting unit, and
wherein, in a case in which a contract for a transaction relating to a lawn is concluded between a customer using the customer terminal and a gardener using the gardener terminal,
the lawn state information generating unit generates lawn state information indicating a state of the lawn provided by the gardener, and transmits the lawn state information to the customer terminal, and
the lawn selecting unit selects the lawn provided by the gardener based on the lawn state information.

2. The information providing system according to claim 1, wherein
the lawn state information includes a use state of the lawn and a fee for a lawn transaction and
the gardener terminal further includes a lawn fee setting unit that sets the fee for the lawn transaction according to the use state of the lawn.

3. The information providing system according to claim 2, wherein the lawn fee setting unit
sets the fee for the lawn transaction to a predetermined price in a case in which the use state of the lawn is indicated as unused, and
sets the fee for the lawn transaction to a price obtained by subtracting an amount of money at a predetermined rate from the predetermined price, in a case in which the use state of the lawn is indicated as used.

4. The information providing system according to claim 3, wherein, in a case in which the use state of the lawn is indicated as used, if the lawn cannot be regenerated, the lawn fee setting unit sets the fee for the lawn transaction to a price obtained by subtracting an amount of money corresponding to an energy amount generated by using a resulting fermented product produced by fermenting the lawn, from the predetermined price.
